(19) United States
(12) Patent Application Publication
(10) Pub. No.: US 2004/0042108 A1
(43) Pub. Date: Mar. 4, 2004

(54) Information processor and storage device control method

(75) Inventor: Hiroshi Kusuyama, Kawanishi-shi (JP)

Correspondence Address: WALL MARJAMA & BILINSKI, 101 SOUTH SALINA STREET, SUITE 400, SYRACUSE, NY, 13202, US

(73) Assignee: Matsushita Electric Industrial Co., Ltd.

(21) Appl. No.: 10/230,853

(22) Filed: Aug. 29, 2002

(51) Int. Cl. G11B 19/04; G11B 21/02

(52) U.S. Cl. 360/60; 360/75

(57) ABSTRACT

The present invention provides an information processor and a storage device control method, which enable a system to stably operate even in very low temperature environments. This information processor includes a HDD 12 having a storage medium that stores data, a motor for driving the storage medium, and a motor for accessing the data on the storage medium, and accesses the data on the storage medium; a thermister 13 for detecting an ambient temperature around the HDD 12; and a microcomputer 15 for controlling the HDD 12 not to perform the data accessing but to start only the motor for driving the storage medium and the motor for accessing the data on the storage medium when the temperature detected by the thermister 13 is lower than a predetermined temperature.

### FIELD OF THE INVENTION

The present invention relates to an information processor and a storage device control method and, more particularly, to an information processor and a storage device control method which can be stably operated even in very low temperature environments.

### BACKGROUND OF THE INVENTION

A hard disk drive (hereinafter, referred to as “HDD”) of a conventional information processor cannot execute a read or write operation normally in very low temperature environments (approximately at −20° C.) due to temperature characteristics of a disk and a head of the HDD. Therefore, there is a limitation on use that the information processor should be used at 5° C. or higher when used at low temperature.

However, when the information processor is a portable information device such as a notebook personal computer and carried out to be used away from home or on the move, the information processor may be operated in very low temperature environments. In such cases, in the above-mentioned conventional processor, the HDD cannot execute the read or write operation normally.

### SUMMARY OF THE INVENTION

The present invention has for its object to provide an information processor and a storage device control method, which enable a system to stably operate even in very low temperature environments.

Other objects and advantages of the present invention will become apparent from the detailed description and specific embodiments described are provided only for illustration since various additions and modifications within the spirit and scope of the invention will be apparent to those of skill in the art from the detailed description.

According to a 1 st aspect of the present invention, there is provided an information processor including: a storage device that has a storage medium for storing data, a motor for driving the storage medium, and a motor for accessing the data on the storage medium, and accesses the data on the storage medium; a temperature detection means for detecting an ambient temperature around the storage device; and a control means for controlling the storage device not to access the data on the storage medium but to start only the motor for driving the storage medium and the motor for accessing the data on the storage medium when the temperature detected by the temperature detection means is lower than a predetermined temperature. Therefore, the system of the information processor can operate stably even in very low temperature environments.

According to a 2nd aspect of the present invention, there is provided a method for controlling a storage device that has a storage medium for storing data, a motor for driving the storage medium and a motor for accessing the data on the storage medium, and accesses the data on the storage medium, including steps of: detecting an ambient temperature around the storage device; and controlling the storage device not to perform the data accessing to the storage medium but to start only the motor for driving the storage medium and the motor for accessing the data on the storage medium when the ambient temperature around the storage device is lower than a predetermined temperature. Therefore, the system of the information processor can operate stably even in very low temperature environments.

### BRIEF DESCRIPTION OF THE DRAWINGS

FIG. 1 is a block diagram illustrating a structure of an information processor according to a first embodiment of the present invention.

FIG. 2 is a flowchart showing a method for controlling a HDD according to the first embodiment.

FIG. 3 is a characteristic diagram showing an example of a relationship between the spindle motor operation time and the HDD ambient temperature in the information processor according to the first embodiment.

### DETAILED DESCRIPTION OF THE PREFERRED EMBODIMENTS

[Embodiment 1]

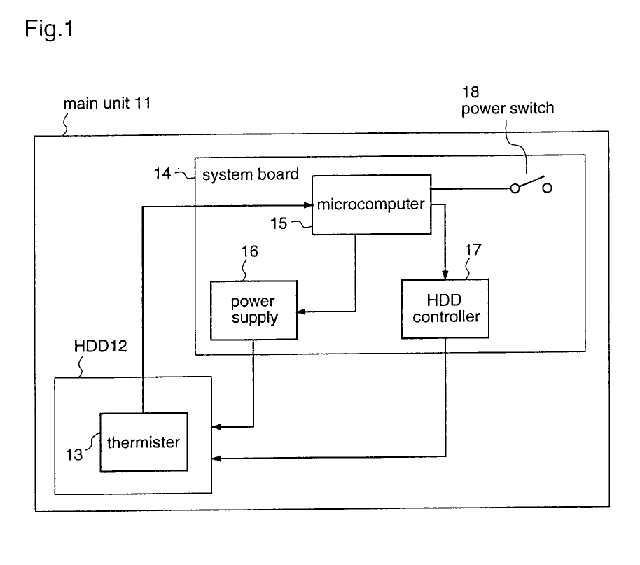

FIG. 1 is a block diagram illustrating a structure of an information processor according to a first embodiment of the present invention.

As shown in FIG. 1, an information processor 11 according to the first embodiment includes a HDD 12 including a disk-type storage medium that stores control programs such as an operating system and application programs, and various data, a spindle motor for driving the disk-type storage medium, and a head for accessing the data on the disk-type storage medium; a thermister 13 that is provided in the proximity of the HDD 12 to detect an ambient temperature around the HDD 12; and a system board 14 for implementing a system of the information processor 11, a power supply, and the like. On the system board 14, a microcomputer 15 for controlling the entire system, a power supply 16 for supplying power to the entire system including the HDD 12, a HDD controller 17 for controlling the action of the HDD 12, and a power switch 18 that is used by the user to start the system are packaged.

Next, a method for controlling the HDD 12 according to the first embodiment will be described.

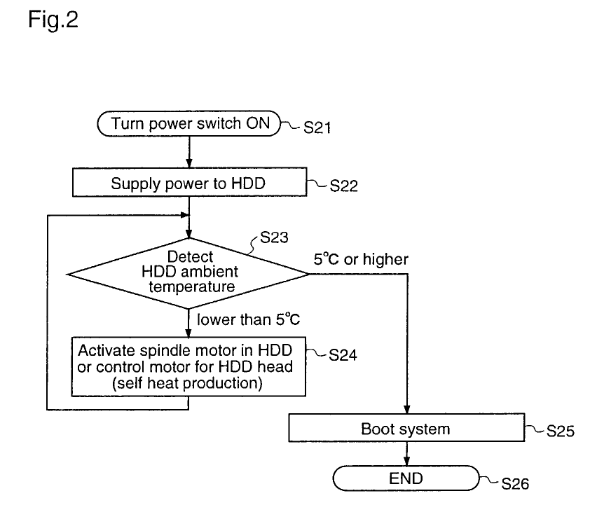

FIG. 2 is a flowchart showing a method for controlling the HDD according to the first embodiment.

Initially, when a user turns ON the power switch 18, information indicating that the power switch is turned ON is detected by the microcomputer 15 (step S21).

After the detection, the microcomputer 15 controls the power supply 16 for supplying power to the entire system including the HDD 12 (step S22).

Then, the microcomputer 15 checks an ambient temperature around the HDD 12, which is detected by the thermister 13 (step S23), and decides whether or not the detected temperature is 5° C. or higher. When the ambient temperature around the HDD 12 is 5° C. or higher, the HDD controller 17 starts the head of the HDD 12 to start the data accessing, thereby executing a normal system booting sequence to boot the system (step S25).

On the other hand, when the microcomputer 15 decides that the ambient temperature around the HDD 12 is lower than 5° C. in step S23, the microcomputer 15 starts the spindle motor in the HDD 12 or the control motor for the head in the HDD 12, thereby to make the HDD 12 itself produce heat (step S24). Thereafter, the operation returns to step S23 to check the ambient temperature around the HDD 12, which is detected by the thermister 13. The thermister temperature monitoring routine from steps S23 to S24 is repeated until the ambient temperature around the HDD 12 becomes 5° C. or higher. After the ambient temperature becomes 5° C. or higher, the HDD controller 17 starts the head of the HDD 12 to start the data accessing, thereby to boot the system.

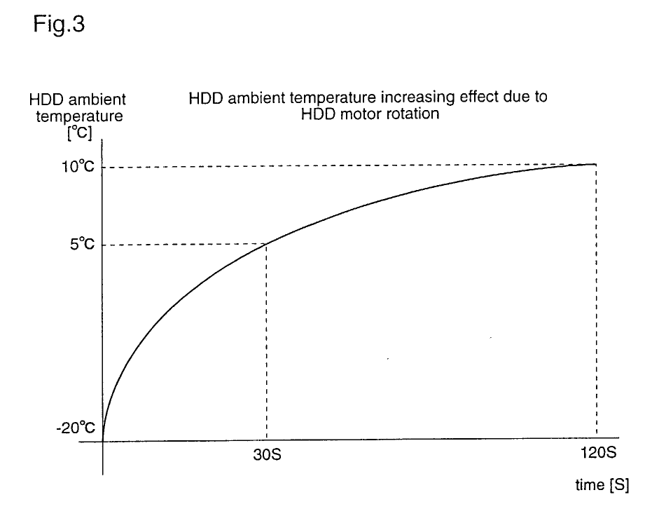

FIG. 3 shows an example of a relationship between the spindle motor operation time and the HDD ambient temperature in the information processor according to the first embodiment. FIG. 3 is a diagram showing the rotating time of the spindle motor in the HDD and the HDD ambient temperature increasing effect according to the first embodiment.

In FIG. 3, the ambient temperature around the HDD 12 abruptly increases at the start of the spindle motor or the control motor for the head and thereafter the temperature increase curve becomes gentle due to heat radiation of the HDD 12 itself, while the temperature reaches approximately 5° C. in about 30 seconds from the start. The time when the temperature reaches approximately 5° C. comes earlier when the surroundings of the HDD 12 are more sealed.

As described above, according to the information processor and the storage device (HDD) control method of the first embodiment, when the HDD ambient temperature detected by the thermister is lower than a predetermined temperature, the HDD is controlled so that the data access is not performed but only the spindle motor is started, whereby the system can operate stably even in the very low temperature environments.

In this first embodiment, the microcomputer 15 decides whether or not the ambient temperature around the HDD 12 is 5° C. or higher. However, the ambient temperature around the HDD 12, which is decided by the microcomputer 15, may be any temperature as long as this is a temperature at which the HDD can operate stably.

Further, when the HDD has such a construction that hardly conducts self-produced heat to the surroundings of the HDD, a waiting time until the system is booted becomes longer. Accordingly, the waiting time may be informed the user as required by using a LED display, a LCD display or the like.

In this first embodiment, the description has been given taking the HDD as an example, while the storage device may be a CD drive or the like as long as it includes a motor.

What is claimed is:

1. An information processor including:
a storage device that has a storage medium for storing data, a motor for driving the storage medium, and a motor for accessing the data on the storage medium, and accesses the data on the storage medium;
a temperature detection means for detecting an ambient temperature around the storage device; and
a control means for controlling the storage device not to access the data on the storage medium but to start only the motor for driving the storage medium and the motor for accessing the data on the storage medium when the temperature detected by the temperature detection means is lower than a predetermined temperature.

2. A method for controlling a storage device that has a storage medium for storing data, a motor for driving the storage medium and a motor for accessing the data on the storage medium, and accesses the data on the storage medium, including steps of:
detecting an ambient temperature around the storage device; and
controlling the storage device not to perform the data accessing to the storage medium but to start only the motor for driving the storage medium and the motor for accessing the data on the storage medium when the ambient temperature around the storage device is lower than a predetermined temperature.
